(19) United States
(12) Patent Application Publication
(10) Pub. No.: US 2016/0018670 A1
(43) Pub. Date: Jan. 21, 2016

(54) COLLAPSIBLE EYEWEAR WITH EXTENDED TEMPLE PIECES

(71) Applicant: Clic Goggles, Inc., Corte Madera, CA (US)

(72) Inventors: Ron Lando, Corte Madera, CA (US); Pietro Messina, Firenze (IT)

(21) Appl. No.: 14/866,985

(22) Filed: Sep. 27, 2015

Related U.S. Application Data
(63) Continuation-in-part of application No. 14/323,979, filed on Jul. 3, 2014.

(51) Int. Cl. G02C 5/00; G02C 5/14; G02C 5/02; G02C 3/00

(52) U.S. Cl. CPC G02C 5/006; G02C 3/006; G02C 5/143; G02C 5/02

(57) ABSTRACT

Eyewear including a pair of lenses and frame halves, each frame half supporting one of the lenses. The eyewear also includes rigid temple pieces having first and second ends, each rigid temple piece being pivotally connected to a frame half at its first end and to a flexible strap at its second end, each of the rigid temple pieces being of a length to pass over and behind the ear of the user such that the flexible strap, whose length can be varied, is U-shaped and drapes over a user's neck when the eyewear is being worn.

### RELATED APPLICATIONS

The present application is a Continuation-In-Part of U.S. application Ser. No. 14/323,979 filed on Jul. 3, 2014.

### TECHNICAL FIELD

The present invention deals with eyewear having a snap-together bridge feature and a flexible strap for enhanced applications and usability.

### BACKGROUND OF THE INVENTION

Applicant is the owner of U.S. Pat. Nos. 6,253,388 and 7,931,366. The invention disclosed and claimed in the '388 patent involved eyewear comprised of a pair of lenses, releasable connectors connecting the respective inner ends of the lenses, a pair of temple pieces pivotal with respect to the outer ends of the lenses and a rigid strap attached to rear ends of the temple pieces including an arc-shaped base bridging its parallel legs which, in turn, are connected to ends of the temple pieces. The strap was taught to be positioned below the lenses so as not to interfere with, for example, the hair style or hat of the user. The inner ends of the lenses were taught to be releasably secured to each other by connectors, preferably, by magnets. To position the eyewear, the lenses are first separated from each other and pivoted outwardly. The strap is then wrapped around the back of the user's head and the lenses pivoted toward each other and secured together in the front of the user's eyes. The lenses were taught to be instantly separable to facilitate putting on and taking off the eyewear and instantly connectable for a secure and accurate fit. The disclosure of the '388 patent is hereby incorporated by reference.

Applicant's U.S. Pat. No. 7,931,366 represents an improvement over the invention disclosed and claimed in the '388 patent by calling for a telescoping segment located within the arc-shaped base of the eyewear's strap to selectively alter the length of the arc-shaped base for modifying the spacing between the substantially parallel legs of the rigid strap and to adjust the strap to varying widths of the user's head. Although doing so greatly expanded the flexibility of applicant's eyewear enabling it to be accommodated by users of different head sizes, it was determined by applicant that its eyewear could benefit yet further by additional modification.

Because of the relatively rigid strap being fixed to the eyewear's temple pieces, even if the lenses were to be separated from each other through the eyewear's releasable connector, the substantially U-shaped strap prevented the eyewear from collapsing compactly. As such, although traditional eyewear can be placed, for example, in the vest pocket of a user by simply pivoting temple pieces against the lenses or their frames when not in use, the eyewear made the subject of the '388 and '366 patents are either worn, hung from the user's neck or placed upon a desk or other surface. Simply put, applicant's prior eyewear could not be conveniently stored.

There have been others who have realized that applicant's previously disclosed eyewear could be made to fold more conveniently and housed in an appropriate storage case by making applicant's previously taught semi-rigid strap flexible. For example, International Application Nos. WO2014/118405, WO2014/181010 and PCT/US2015/032438 disclose the use of a flexible strap and, to maintain the strap's S-shape, it was taught that the strap be made of a memory material molded to the appropriate shape. Clearly, the inventors of the International Application were inspired by the teachings of applicant's own '388 patent which taught the benefits of configuring the strap joining the ends of the temple pieces to be S-shaped for the reasons noted above. Applicant itself improved yet further upon this concept in its parent U.S. application Ser. No. 14/323,979 employing both a flexible strap and hinges configured within each temple piece to improve foldability and compactness of such eyewear when not in use.

In applicant's continued effort to improve upon the eyewear of the prior art, certain limitations inherent therein have been recognized. Specifically, it has been noted that the combination of the eyewear's snap-together bridge feature and flexible strap cause it to seem a bit unstable as compared to conventional eyewear when worn. Thus, the eyewear of the prior art is not ideally wearable as lacking the necessary rigidity required by a user. Further, the necessity to maintain the strap's S-shape requires that it be composed of a memory material which limits the choices of such material and requires a more complex mold, specifically, one having an S-shape. Finally, there is no teaching in the prior art of providing the ability to lengthen or shorten the flexible strap to accommodate wearers' varying head sizes, hairdos and hats.

It is thus an object to the present invention to provide eyewear having a snap-together bridge feature and flexible strap enabling such eyewear to readily collapsed and be stored while overcoming the limitations the prior art.

It is yet another object of the present invention to provide eyewear is not only comfortable to wear but collapsible for convenient storage also possessing the rigidity required by a user.

It is yet a further object of the present invention to provide eyewear having a snap-together bridge feature and flexible strap capable of adjustment along the rear end of the extended rigid temple pieces to thus provide such eyewear to a greater segment of the using public.

These and further objects will be readily apparent when considering the following disclosure and appended claims.

### SUMMARY OF THE INVENTION

Eyewear comprising a pair of lenses and frame halves, each frame half supporting one of said lenses, temple pieces having first and second ends, each temple piece being pivotally connected to a frame half at its first end and to a flexible strap at its second end, each of said temple pieces being of a length to pass over and behind the ear of the user such that said flexible strap is U-shaped and drapes over a user's neck when said eyewear is being worn.

Eyewear comprising a pair of lenses and frame halves, each frame half supporting one of said lenses, temple pieces and a strap, a pair of releasable connectors connected to respective inner ends of said frame halves, each temple piece having a first segment and a second segment, each of said first segment having a first end and a second end, each first end being pivotally connected to a frame half, each second segment having a first end and a second end, said first end of the second segment being pivotally connected to a second end of said first segment and said second end of said second segment being captured by a strap and together with said first segment being of a length to pass over and behind an ear of the user such that said strap is U-shaped and flexible and drapes over a user's neck when worn.

Eyewear comprising a pair of lenses and frame halves, each frame half supporting one of said lenses, temple pieces having first and second ends, each temple piece being rigid and pivotally connected to a frame half at its first end and to a flexible strap at its second end, each of said temple pieces being of a length to pass over and behind the ear of the user such that said flexible strap is U-shaped and drapes over a user's neck when said eyewear is being worn and wherein said flexible strap can be lengthened and shortened by telescoping segments of said flexible strap proximate said temple pieces.

Eyewear comprising a pair of lenses and frame halves, each frame half supporting one of said lenses, rigid temple pieces and a strap, a pair of releasable connectors connected to respective inner ends of said frame halves, each rigid temple piece having a first segment and a second segment, each of said first segment having a first end and a second end, each first end being pivotally connected to a frame half, each second segment having a first end and a second end, said first end of the second segment being pivotally connected to a second end of said first segment and said second end of said second segment being captured by a strap and together with said first segment being of a length to pass over and behind an ear of the user such that said strap is U-shaped and flexible and drapes over a user's neck when worn and wherein said flexible strap can be lengthened and shortened by telescoping segments of said flexible strap proximate said temple pieces.

### BRIEF DESCRIPTION OF THE FIGURES

FIG. 1 is a perspective view of a first embodiment of the present invention.

FIG. 2 is a perspective view of a second embodiment of the present invention.

FIG. 3 is a side view of the second embodiment of the present invention shown being worn by a user.

FIG. 4 is a top view of the second embodiment of the present invention in its semi-collapse state.

FIG. 5 is a top view of the second embodiment of the eyewear of the present invention showing its further manipulation carried out during the process of its collapse.

FIG. 6 is a side plan view of the second embodiment of the eyewear of the present invention in its fully collapsed state being introduced to a case for storage.

FIGS. 7 and 7A are side views of other embodiments of the present invention showing the expandability feature of the eyewear's strap feature.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

As noted previously, applicant has taught, in its U.S. Pat. No. 6,253,388, eyewear which includes lenses 10 optionally mounted in respective first and second frame halves 14A and 14B. Connectors, such as magnets which selectively secure the frame halves to one another are attached to the inner ends of the frame halves or to the lenses themselves if the frames are eliminated. Temples 12 are preferably telescoping for fitting different wearers. Without this feature, an attempt to wear applicant's eyewear with it snap-together bridge feature could, and often times does, inadvertently lose connection at the bridge resulting in lens separation.

As further noted in applicant's '388 patent, a strap is connected to one of the eyewear's temple pieces which extends therefrom progressing to a downward segment and connected to an opposite segment at the opposite temple piece for creating a U-shaped base. Together, the strap takes on an S-shaped configuration to enable it to transition from the ends of the temples to reside, at its base, below what would generally be a hair style or hat of the user so as not interfere with these features.

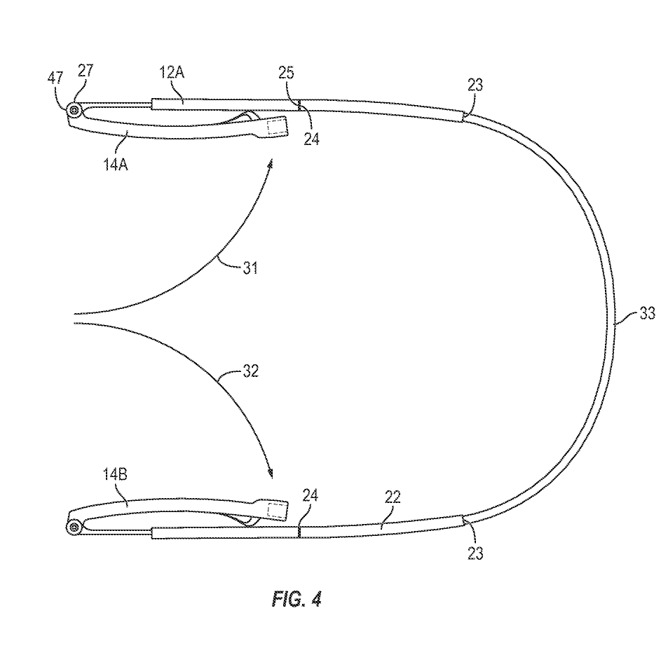

Although applicant's prior eyewear with its unique snap-together bridge feature represented a significant advancement in the art, it was not without its limitations. Significant among them resulted from the use of a strap which was rigid. The strap was to maintain the eyewear properly positioned with its lenses in front of the user's eyes. However, when a user did not require the employment of this eyewear, it simply hung from the user's neck with its lenses 10 and frame halves 14A and 14B pivoted about a hinge such as depicted schematically by arrows 31 and 32 of FIG. 4. However, if the user wishes to completely remove the eyewear for storage, its rigid strap would prevent the eyewear from compactly fitting within a case or receptacle. Nevertheless, the rigid strap formed a valuable function. Because of the releasable connector 11 which characterizes all of such eyewear, the frame halves and their contained lenses can slightly rotate with respect to one another and the rigid strap providing a level of secured attachment which users generally appreciate. However, to aid in the compact storage of such eyewear, the prior art, and specifically International Application Nos. WO2014/118405, WO2014/181010 and PCT/US2015/032438 as well as applicant's own parent U.S. application Ser. No. 14/323,979 taught the use of a flexible strap which, although facilitating storage caused the eyewear to somewhat lose its sought after rigidity. The present invention addresses this critical issue making the eyewear of the present invention more secure while maintaining lenses 10 in front of the user's eyes when worn.

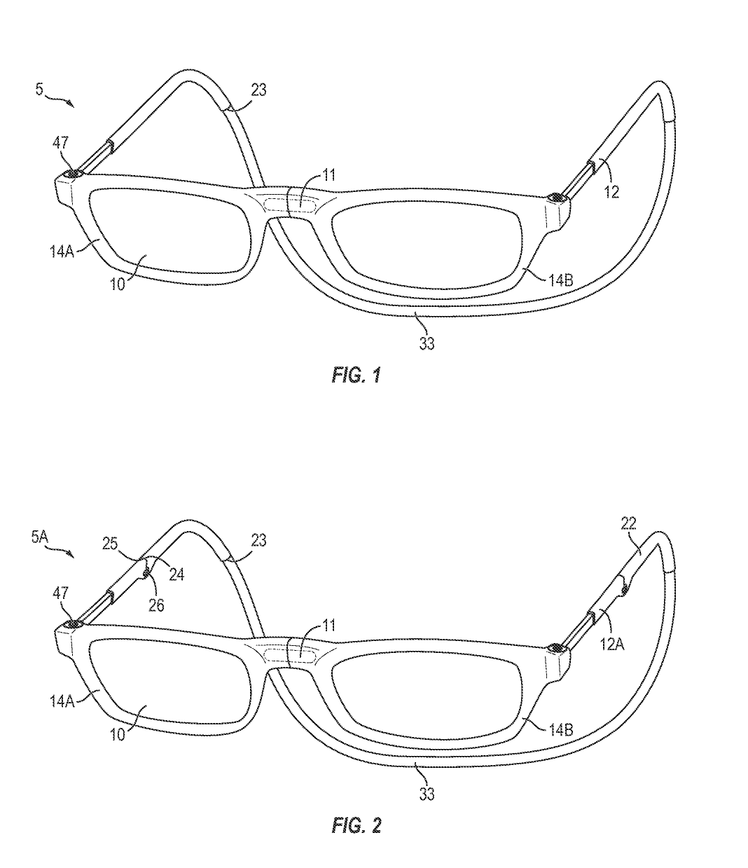

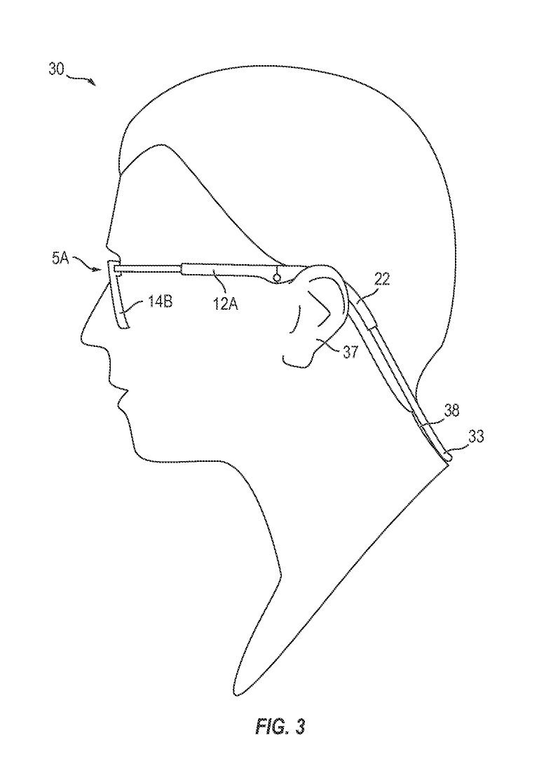

Turning first to FIG. 1, eyewear 5 is shown comprising a pair of lenses 10, frame halves 14A and 14B supporting these lenses and a pair of releasable connectors generally in the form of magnets 11 positioned on the inner ends of the frame halves. Strap 33 consists of a flexible band composed of any of a wide variety of materials which can but need not retain it shape. Suitable examples of such materials include, without limitation, thermoplastic elastomers such as styrene block polymers, latex and silicone rubber, wire, cord, string, thread, and woven and unwoven fabric. Suitable strap material should be flexible enough to bend or fold without deforming or breaking and which can be stored for a protracted period of time. Thus, strap 33 can be folded upon itself or wrapped about frame members 14A and 14B for storage. Whether the embodiment of FIG. 1 or that of FIG. 2 is chosen, the key feature of the present invention pertains to its rigid temple pieces. In order to appreciate this key feature further, reference is made to FIG. 3.

In turning to FIG. 3, eyewear 5A is shown being employed by user 30. Specifically, eyewear 5A sits on the bridge of the user's nose while the temple pieces, being rigid composed of subparts 12A and 22, together, are of a length to pass over and behind ear 37 of user 30 and preferably hook over and extend toward the transition between the shoulders and neck of a user and before connection is made to flexible strap 33. When so constructed, flexible strap 33 is substantially U-shaped and drapes over, and is ideally in contact with, user's neck 38. This is in contrast to related eyewear of the prior art in which their temple pieces are much shorter requiring that their straps either be rigid or composed of memory material in order to maintain a suitable S-shape configuration. This distinction is significant for several reasons. Firstly, temple pieces, being rigid, are able to stabilize the eyewear on a user's nose when such temple pieces extend past the user's ear and, preferably, extend downwardly when joined to an appropriate flexible strap. Secondly, by extending the temple pieces as shown, the flexible strap need not be S-shaped to avoid the strap from interfering with a hair style or hat of the user and, as such, dedicated molds need not be employed nor is a manufacturer required to produce a strap of memory material.

Although the embodiment of FIG. 2 was employed in discussing the features of the present invention in reference to FIG. 3, the embodiment of FIG. 1 could have just as well been referenced as the thrust of the present invention remains the same regardless of which embodiment is chosen. However, the embodiment of FIG. 2 aids in the further compactness and storage of the present eyewear.

In turning to the embodiment of FIG. 2, eyewear 5A is provided with rigid temple pieces that have been segmented, each side of the eyewear having two such temple segments separated by hinge 26. More specifically, each rigid temple piece is composed of first segment 12A and second segment 22, the first segment having a first end 27 and second end 25, each first end 27 being pivotally connected to a frame member by hinge 47. Each second segment 22 is also provided with a first end 24 and a second end 23, the first end 24 of each second segment 22 is pivotally connected to second end 25 of first segment 12A at hinge 26. Again, significantly, second segment 22 of the rigid temple pieces, together with first segment 12A extend the rigid temple pieces beyond the ear of the user for the reasons expressed previously.

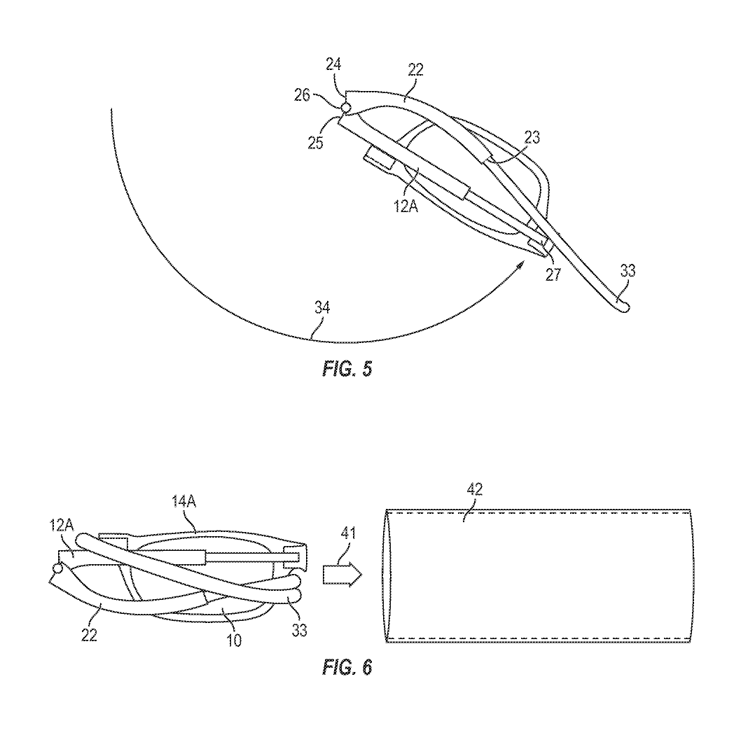

As noted, strap 33 captures second end 23 of second segment 22 such that as first segment 12A rotates in the direction of arrow 34 about pivot 26, strap 33 nests as shown in FIG. 5. More specifically, in preparing eyewear 5A for storage, a user would first separate frame halves 14 and 14A by releasing connector 11. Lenses 10 together with their supporting frame members are rotated along pivots 47 in the direction of arrows 31 and 32 such that lenses 10 and frame halves 14 and 14A are positioned against first temple pieces 12A. Thereupon, second segments 22 are rotated at their first ends 24 with respect to second ends 25 of first segments 12A as shown schematically by arrow 34 of FIG. 5 such that first and second rigid temple segments 12A and 22, respectively, extend substantially adjacent to one another as best depicted in FIGS. 5 and 6. In addition, strap 33 can be folded upon itself a wrapped about lenses 10 and frame members 14A and 14B for insertion within compact storage container 42 (FIG. 6).

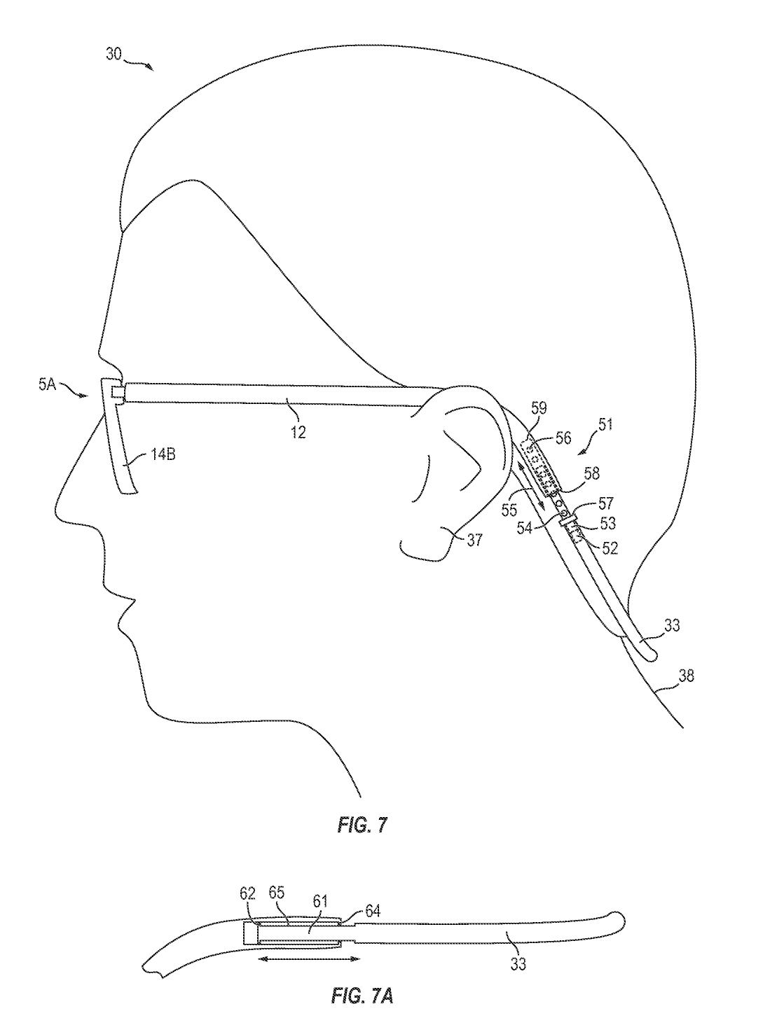

As noted previously, applicant's previously taught that temples 12 can be telescoping for fitting different wearers. Although this feature can also characterize the present invention, as yet a further embodiment, reference is made to FIGS. 7 and 7A which provide for the ability of the present eyewear, and particularly its strap 33 to telescope or change length as needed to accommodate users' varying head sizes, hairdos and hats.

In turning to FIG. 7, eyewear 5A is shown being employed by user 30. Eyewear 5A sits on the bridge of the user's nose while temple pieces 12, being rigid are of a length to pass over and behind ear 37 of user 30. As noted previously, flexible strap 33 is substantially U-shaped and drapes over, and is ideally in contact with user's neck 38. Recognizing that users can be of a variety of shapes and sizes, it was found, as a preferred embodiment, to provide the ability to selectively lengthen and shorten strap 33 to encourage it to rest upon and be supported by neck 38 of a user by telescoping segments of flexible strap 33 proximate temple pieces 12. Although there are many ways to telescope flexible strap 33 to and from the ends of temples 12 as depicted schematically by arrows 55, two such expedients are depicted merely for the purpose of illustration. In further reference to FIG. 7, element 51 composed of, for example, metal or rigid plastic, can be provided with undulating segment 52 for insertion within end portion 57 of strap 33 and further having stem 53 with pins 54 extending therefrom.

Corresponding female segment 59 is embedded within flexible strap 33 at end 58 for receiving stem 53 and pins 54 within pin receiving openings 56. Thus, a user can pull or push upon flexible strap 33 proximate its ends 57 and 58 to enable stem 53 to slide with respect to female segment 59 to facilitate contact between flexible strap 33 and a user's neck 38. In doing so, eyewear 5 will be encouraged to sit properly upon the bridge of the user's nose and not lift up there from due to the weight of flexible strap 33. As noted in reference to FIG. 7A, the expansion element can be made of flexible material, in this example, from the same material that constitutes the strap itself. Specifically, strap 33 is provided with reduced segment 61 terminating in head 62. The mating side of the strap has a hollow segment 65 sized to receive reduced segment 61 and head 62 for sliding engagement therein. Stops 64 are configured within the hollow segment 63 to prevent inadvertent disengagement of the strap segments as head portion 62 is larger than the opening created by stops 64.

Although the embodiment of FIG. 1 was employed in discussing certain features the present invention in reference to FIGS. 7 and 7A, the embodiment of FIG. 2 could have just as well been referenced as the thrust of the preferred embodiments of FIGS. 7 and 7A remain the same regardless of which embodiment is chosen.

The present invention provides improved eyewear having clear advantages over the prior art. Not only is such eyewear capable of being compactly stored when not worn, but its extended rigid packaging for the product temple pieces provide needed rigidity when a flexible band is combined with releasable connectors which characterize eyewear of this type. In addition, strap materials of virtually any kind can be employed which, unlike the prior art, need not exhibit a memory feature nor be molded in any S-shape or any other shape for use herein. In fact, a suitable strap material for use in carrying out the present invention can be nothing more than a linear piece of rubber which takes on a U-shape when its ends are appended to the terminal ends of appropriately configured temple pieces. Finally, this eyewear is capable of providing the ability to lengthen or shorten the flexible strap along the rear ends of the extended rigid temple pieces to accommodate wearers' varying head sizes, hairdos or hats.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. Eyewear comprising a pair of lenses and frame halves, each frame half supporting one of said lenses, temple pieces having first and second ends, each temple piece being rigid and pivotally connected to a frame half at its first end and to a flexible strap at its second end, each of said temple pieces being of a length to pass over and behind the ear of the user such that said flexible strap is U-shaped and drapes over a user's neck when said eyewear is being worn.

2. Eyewear comprising a pair of lenses and frame halves, each frame half supporting one of said lenses, rigid temple pieces and a strap, a pair of releasable connectors connected to respective inner ends of said frame halves, each rigid temple piece having a first segment and a second segment, each of said first segment having a first end and a second end, each first end being pivotally connected to a frame half, each second segment having a first end and a second end, said first end of the second segment being pivotally connected to a second end of said first segment and said second end of said second segment being captured by a strap and together with said first segment being of a length to pass over and behind an ear of the user such that said strap is U-shaped and flexible and drapes over a user's neck when worn.

3. The eyewear of claim 1 wherein said second end of said rigid temple pieces hook over the ears of a user and extend toward the transition between the shoulders and neck of a user such that when worn, said flexible strap is in contact with a user's neck.

4. The eyewear of claim 2 wherein said second end of said second segment of said rigid temple pieces hook over the ears of a user and extend toward the transition between the shoulders and neck of a user such that when worn, said flexible strap is in contact with a user's neck.

5. The eyewear of claim 1 wherein said flexible strap can be lengthened and shortened by telescoping segments of said flexible strap proximate said temple pieces.

6. The eyewear of claim 2 wherein said flexible strap can be lengthened and shortened by telescoping segments of said flexible strap proximate said temple pieces.

7. Eyewear comprising a pair of lenses and frame halves, each frame half supporting one of said lenses, temple pieces having first and second ends, each temple piece being rigid and pivotally connected to a frame half at its first end and to a flexible strap at its second end, each of said temple pieces being of a length to pass over and behind the ear of the user such that said flexible strap is U-shaped and drapes over a user's neck when said eyewear is being worn and wherein said flexible strap can be lengthened and shortened by telescoping segments of said flexible strap proximate said temple pieces.

8. Eyewear comprising a pair of lenses and frame halves, each frame half supporting one of said lenses, rigid temple pieces and a strap, a pair of releasable connectors connected to respective inner ends of said frame halves, each rigid temple piece having a first segment and a second segment, each of said first segment having a first end and a second end, each first end being pivotally connected to a frame half, each second segment having a first end and a second end, said first end of the second segment being pivotally connected to a second end of said first segment and said second end of said second segment being captured by a strap and together with said first segment being of a length to pass over and behind an ear of the user such that said strap is U-shaped and flexible and drapes over a user's neck when worn and wherein said flexible strap can be lengthened and shortened by telescoping segments of said flexible strap proximate said temple pieces.
